(19) United States
(12) Patent Application Publication
(10) Pub. No.: US 2008/0274695 A1
(43) Pub. Date: Nov. 6, 2008

(54) Bluetooth-enabled system and related method

(75) Inventor: James Michael Muth, Santa Ana, CA (US)

Correspondence Address: FARJAMI & FARJAMI LLP, 26522 LA ALAMEDA AVENUE, SUITE 360, MISSION VIEJO, CA, 92691, US

(73) Assignee: BROADCOM CORPORATION, IRVINE, CA (US)

(21) Appl. No.: 11/904,524

(22) Filed: Sep. 26, 2007

Related U.S. Application Data
(60) Provisional application No. 60/927,198, filed on May 2, 2007.

(51) Int. Cl. H04B 7/00

(52) U.S. Cl. 455/41.2

(57) ABSTRACT

According to one exemplary embodiment, a Bluetooth-enabled system includes a computer coupled to a Bluetooth-enabled host, e.g. a Bluetooth-enabled IP phone, via a communication link, where the communication link can be either an Ethernet link or a WLAN link. The Bluetooth-enabled system further includes at least one Bluetooth-enabled input device, e.g. a Bluetooth-enabled mouse or keyboard, being capable of communicating with the Bluetooth-enabled host via a Bluetooth link. The Bluetooth-enabled host is configured to transmit data received via the Bluetooth link from the at least one Bluetooth-enabled input device to the computer via the communication link. The communication link can utilize a TCP/IP protocol.

The present application claims the benefit of and priority to a pending provisional patent application entitled “Bluetooth Keyboard and Mouse Using an IP Phone,” Ser. No. 60/927,198 filed on May 2, 2007. The disclosure in that pending provisional application is hereby incorporated fully by reference into the present application.

### BACKGROUND OF THE INVENTION

1. Field of the Invention

The present invention generally relates to the field of computers and communications. More particularly, the invention relates to computers and Bluetooth communications.

2. Background Art

Many input devices for computers are manufactured with Bluetooth capability. These Bluetooth-enabled input devices can conveniently work with other portable devices without the requirement of physical wires. Manufacturers have adopted the Bluetooth standard to ensure compatibility among devices and to reduce or eliminate the need for user intervention during initial setup of these devices. Due to this added convenience, the Bluetooth standard has been especially popular among portable computing devices, such as laptop computers.

The Bluetooth standard is advantageous over its more common predecessor, the wireless USB, mainly because Bluetooth is a fully integrated wireless standard. In contrast to the Bluetooth standard, wireless USB requires both its underlying USB communication system and an additional non-standardized wireless transceiver. As a result, some disadvantages wireless USB has with respect to Bluetooth are that, for example, there is no interoperability of devices among different computers and the quality of the wireless communication link is not guaranteed.

Despite the advantages of Bluetooth, the desktop computer market has been slow to embrace Bluetooth technology. Most OEM desktop computer manufacturers do not offer Bluetooth-enabled desktop computer systems alongside their current standardized connectivity options, which include legacy PS/2, USB/USB2, and IEEE 1394 FireWire. Integrating a new standard is costly and manufacturers tend to avoid the risk of increasing production costs that may be difficult to recover given the already narrow profit margins experienced in the personal computing market. As a result, the individual consumer will have to shoulder the additional cost and inconvenience of an after-market Bluetooth dongle in order to use their Bluetooth-enabled input devices with their desktop computer.

### SUMMARY OF THE INVENTION

A Bluetooth-enabled system and related method substantially as shown in and/or described in connection with at least one of the figures, as set forth more completely in the claims.

### BRIEF DESCRIPTION OF THE DRAWINGS

FIG. 1 shows a diagram of a conventional exemplary Bluetooth-enabled system including a computer capable of communicating with a Bluetooth enabled mouse and keyboard by a Bluetooth dongle.

FIG. 2 shows a diagram of an exemplary Bluetooth-enabled system including a computer capable of communicating with a Bluetooth-enabled mouse and keyboard by a Bluetooth-enabled IP phone in accordance with one embodiment of the present invention.

FIG. 3 shows a flowchart illustrating exemplary steps taken to implement an embodiment of the present invention.

### DETAILED DESCRIPTION OF THE INVENTION

The present invention is directed to a Bluetooth-enabled system and related method. The following description contains specific information pertaining to the implementation of the present invention. One skilled in the art will recognize that the present invention may be implemented in a manner different from that specifically discussed in the present application. Moreover, some of the specific details of the invention are not discussed in order not to obscure the invention.

The drawings in the present application and their accompanying detailed description are directed to merely exemplary embodiments of the invention. To maintain brevity, other embodiments of the present invention are not specifically described in the present application and are not specifically illustrated by the present drawings.

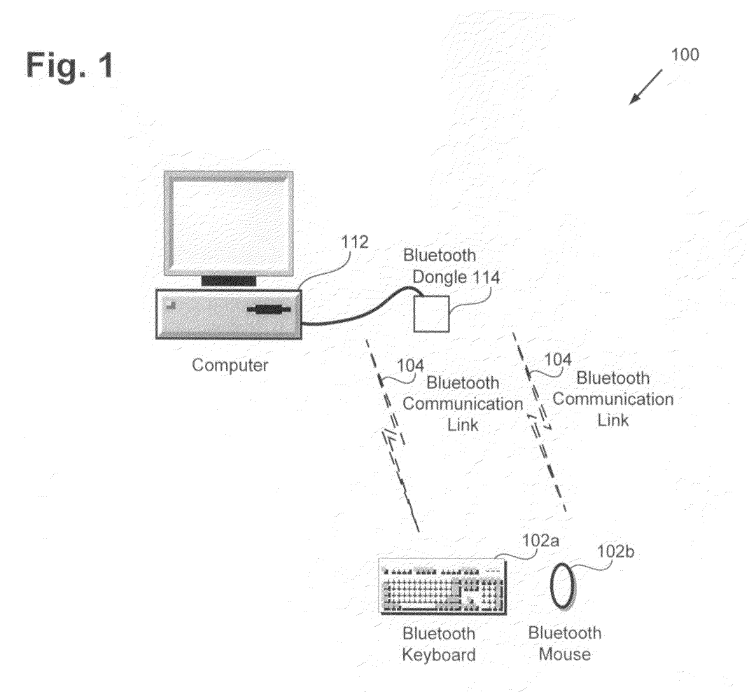

FIG. 1 shows a diagram of a conventional Bluetooth-enabled system. Conventional Bluetooth-enabled system 100 includes Bluetooth keyboard 102a, Bluetooth mouse 102b, computer 112, and Bluetooth dongle 114. As shown in FIG. 1, Bluetooth keyboard 102a and Bluetooth mouse 102b are capable of communicating with computer 112 via Bluetooth dongle 114 and Bluetooth link 104. Computer 112 is a typical desktop personal computer (PC) that is not Bluetooth enabled, i.e., it does not have manufacturer-integrated Bluetooth capability. Thus, in order for Bluetooth-enabled input devices such as Bluetooth keyboard 102a or Bluetooth mouse 102b to be used with computer 112, an aftermarket Bluetooth adapter such as Bluetooth dongle 114 must be connected to computer 112. Bluetooth dongle 114 can be connected to computer 112 by hard wire, as shown, or by directly plugging into a USB port of computer 112, or by any other means.

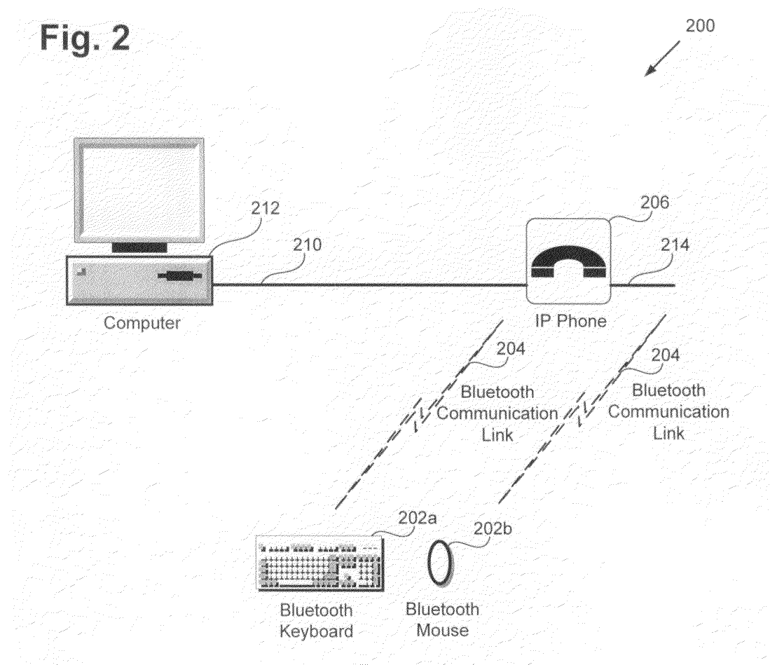

FIG. 2 shows the diagram of Bluetooth-enabled system 200 in accordance with one embodiment of the present invention. Bluetooth-enabled system 200 includes Bluetooth keyboard 202a, Bluetooth mouse 202b, Bluetooth-enabled IP phone 206 (which is an example of what is generally referred to as Bluetooth-enabled host in the present application), and computer 212. Bluetooth keyboard 202a and Bluetooth mouse 202b are examples of Bluetooth-enabled input devices that can be utilized in the present invention. Other Bluetooth-enabled input devices that may be utilized in various embodiments of the invention's Bluetooth-enabled system can include a microphone, a game controller, a touchpad, a touch screen, a joystick, a camera, a scanning device, a fingerprint reader, or any other type of Human Interface Device (HID) or input device.

As shown in FIG. 2, Bluetooth keyboard 202a and Bluetooth mouse 202b are capable of communicating with Bluetooth-enabled host 206 (e.g., Bluetooth-enabled IP phone 206) by Bluetooth link 204, and Bluetooth-enabled host 206 is coupled to computer 212 by communication link 210. Bluetooth-enabled host 206 can be coupled to a network, such as a wide area Ethernet network, by communication link 214. In the present embodiment, Bluetooth-enabled host 206 can be an IP phone. In other embodiments, Bluetooth-enabled host 206 can be a laptop computer, a personal digital assistant, or other type of Bluetooth-enabled device that can be coupled to computer 212 via an Ethernet or wireless local area network (WLAN) link. Communication link 210 can be an Ethernet or WLAN link and can utilize, for example, a TCP/IP protocol. Communication links 210 and 214 can be implemented by using a cable, such as a category (CAT) 5, CAT5e, CAT6, or CAT7 Ethernet cable. Computer 212 can be an immobile computer, such as a desktop computer, a workstation, or the like.

The operation of Bluetooth-enabled system 200 will now be discussed. Each Bluetooth-enabled input device, e.g., Bluetooth keyboard 202a and Bluetooth mouse 202b, detects inputs, such as key strokes in Bluetooth keyboard 202a or movements of Bluetooth mouse 202b, and generates corresponding input data in the form of an HID (Human Interface Device) report. The Bluetooth-enabled input device then transmits the HID report to Bluetooth-enabled host 206, e.g. Bluetooth-enabled IP phone 206 in the present embodiment, via Bluetooth link 204. Bluetooth-enabled host 206 maintains communication with each Bluetooth-enabled input device via Bluetooth link 204. Bluetooth-enabled host 206 can be configured to process the HID report received from the Bluetooth-enabled input device, extract the input data included in the HID report, convert the input data into TCP/IP packet(s), and transmit the TCP/IP packet(s) to computer 212 over communication link 210. Bluetooth-enabled host 206 can process the HID report and extract the input data in the HID report by utilizing, for example, a Bluetooth stack and an HID profile application.

Computer 212 can be configured to receive the TCP/IP packet(s) from Bluetooth-enabled host 206, e.g. Bluetooth-enabled IP phone 206, via communication link 210 and process the TCP/IP packet(s) to extract the input data generated by the Bluetooth-enabled input devices. Once extracted from the TCP/IP packet(s), the input data from Bluetooth-enabled input devices (e.g. keyboard 202a and/or mouse 202b) can be appropriately utilized by an operating system and suitable applications that reside in computer 212. Computer 212 can process the TCP/IP packet(s) by utilizing, for example, a software application that resides on a hard drive in the computer.

Thus, Bluetooth-enabled system 200 can provide input data from a Bluetooth-enabled input device, such as a Bluetooth keyboard or a Bluetooth mouse, to an immobile computer (e.g. a desk top computer or a work station) by utilizing a communication link, such as an Ethernet or WLAN link, established between the computer and the Bluetooth-enabled host, such as an IP phone, and a Bluetooth link established between the Bluetooth-enabled host and the Bluetooth-enabled input device without requiring a Bluetooth dongle connected to the computer. By not requiring a Bluetooth dongle for communication between a Bluetooth-enabled input device and a computer, the invention advantageously saves the cost and inconvenience of installing the Bluetooth dongle, as required in conventional Bluetooth-enabled system 100 in FIG. 1.

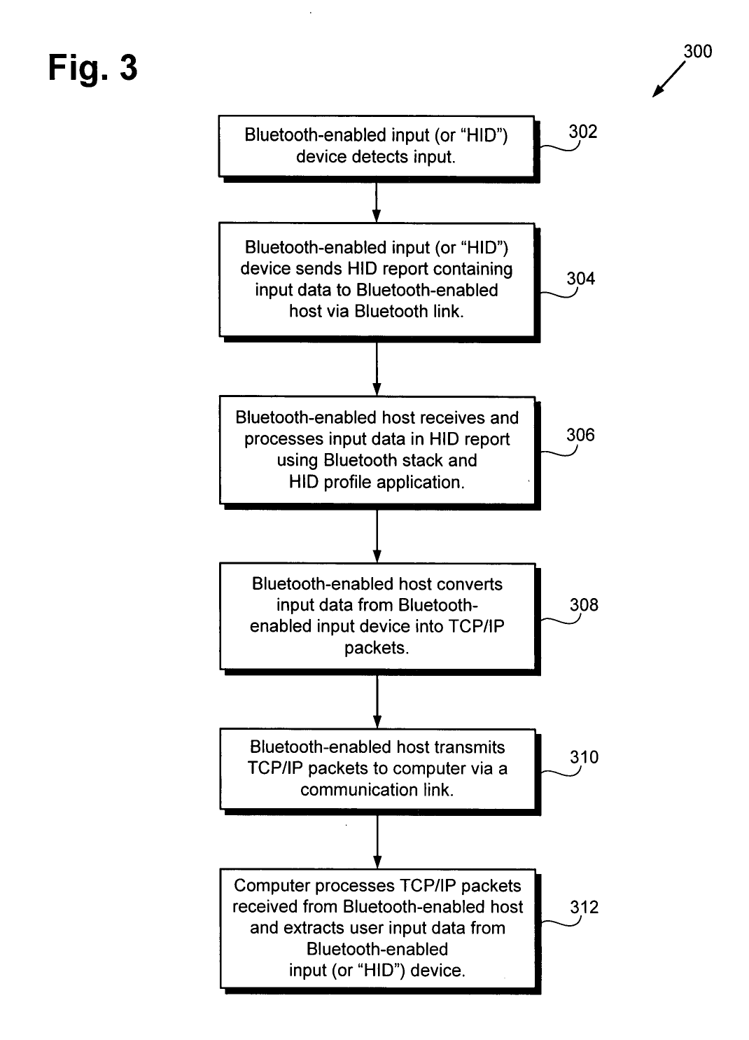

FIG. 3 shows a flowchart illustrating an exemplary method according to an embodiment of the present invention. Certain details and features have been left out of flowchart 300 that are apparent to a person of ordinary skill in the art. For example, a step may consist of one or more substeps or may involve specialized software and/or hardware, as known in the art.

Referring now to step 302 of flowchart 300 in FIG. 3, a Bluetooth-enabled input device (also referred to as a Bluetooth-enabled HID device), such as Bluetooth keyboard 202a or Bluetooth mouse 202b in FIG. 2, detects input, such as a key stroke or a mouse movement. At step 304 of flowchart 300, the Bluetooth-enabled input device (also referred to as a Bluetooth-enabled HID device) sends an HID report containing input data corresponding to the detected input to a Bluetooth-enabled host, such as Bluetooth-enabled IP phone 206, via a Bluetooth link, such as Bluetooth link 204. In other embodiments, other Bluetooth-enabled hosts, such as a laptop computer or a personal digital assistant, can be used as long as the Bluetooth-enabled host can be coupled to a computer via a communication link, such as an Ethernet or WLAN link.

At step 306 of flowchart 300, the Bluetooth-enabled host, such as Bluetooth-enabled IP phone 206, receives the input data in the HID report from the Bluetooth-enabled input device and processes the data using a Bluetooth stack and an HID profile application. At step 308 of flowchart 300, the Bluetooth-enabled host converts the input data from the Bluetooth-enabled input device into TCP/IP packet(s). One task of the Bluetooth-enabled host is to convert the input data from the Bluetooth-enabled input device into TCP/IP packets.

At step 310 of flowchart 300, the Bluetooth-enabled host transmits the TCP/IP packet(s) to a computer, such as computer 212, via a communication link, such as communication link 210, by utilizing a TCP/IP protocol. The communication link can be, for example, an Ethernet or WLAN link and can be implemented by a cable, such as a CAT5, CAT5e, CAT6, or CAT7 cable. At step 312 of flowchart 300, the computer processes the TCP/IP packet(s) received from the Bluetooth-enabled host and extracts the user input data from the Bluetooth-enabled input device. After the input data has been extract, the input data can be utilized by the computer's operating system and suitable applications that reside in the computer. For example, a cursor can be moved and displayed at a desired location of the computer's screen or a typed character can be displayed.

In sum, the present invention advantageously provides a user with a Bluetooth-enabled system without having to buy and install a separate Bluetooth dongle. Thus, the user who wishes to use Bluetooth-enabled devices with a computer can avoid cost and inconvenience by using the invention's Bluetooth-enabled system, which can include a Bluetooth-enabled host, such as an IP phone, and one or more Bluetooth-enabled input devices, such as a Bluetooth keyboard and/or a Bluetooth mouse.

From the above description of the invention it is manifest that various techniques can be used for implementing the concepts of the present invention without departing from its scope. Moreover, while the invention has been described with specific reference to certain embodiments, a person of ordinary skill in the art would appreciate that changes can be made in form and detail without departing from the spirit and the scope of the invention. Thus, the described embodiments are to be considered in all respects as illustrative and not restrictive. It should also be understood that the invention is not limited to the particular embodiments described herein but is capable of many rearrangements, modifications, and substitutions without departing from the scope of the invention.

Thus, a Bluetooth-enabled system and related method have been described.

1. A Bluetooth-enabled system comprising:
a computer coupled to a Bluetooth-enabled host via a communication link, said communication link being selected from the group consisting of an Ethernet link and a WLAN link;
at least one Bluetooth-enabled input device being capable of communicating with said Bluetooth-enabled host via a Bluetooth link;
said Bluetooth-enabled host being configured to transmit data received via said Bluetooth link to said computer via said communication link.

2. The Bluetooth-enabled system of claim 1, wherein said Bluetooth-enabled host is selected from the group consisting of an IP phone, a laptop computer, and a personal digital assistant.

3. The Bluetooth-enabled system of claim 1, wherein said communication link utilizes a TCP/IP protocol.

4. The Bluetooth-enabled system of claim 1, wherein said at least one Bluetooth-enabled input device is selected from the group consisting of a mouse, a keyboard, a microphone, a game controller, a touchpad, a touch screen, a joystick, a camera, a scanning device, and a fingerprint reader.

5. The Bluetooth-enabled system of claim 1, wherein said computer is an immobile computer.

6. The Bluetooth-enabled system of claim 1, wherein said computer is not Bluetooth enabled.

7. The Bluetooth-enabled system of claim 1, wherein said Bluetooth-enabled host is further configured to convert said data received from said at least one Bluetooth-enabled input device into TCP/IP packets.

8. The Bluetooth-enabled system of claim 8, wherein said computer is configured to receive said TCP/IP packets from said Bluetooth-enabled host and to extract said data from said at least one Bluetooth-enabled input device.

9. The Bluetooth-enabled system of claim 8, wherein said Bluetooth-enabled host is further configured to process said data received from said at least one Bluetooth-enabled input device by utilizing an HID profile application.

10. The Bluetooth-enabled system of claim 1, wherein said Ethernet link is implemented by using a cable selected from the group consisting of CAT5, CAT5e, CAT6, and CAT7.

11. A method for receiving input data from at least one Bluetooth-enabled input device by a computer, said computer being coupled to a Bluetooth-enabled host via a communication link, said method comprising steps of:
receiving said input data in said Bluetooth-enabled host from said at least one Bluetooth-enabled input device via a Bluetooth link;
transmitting said input data from said Bluetooth-enabled host to said computer via said communication link, said communication link being selected from the group consisting of an Ethernet link and a WLAN link.

12. The method of claim 11 further comprising a step of transmitting said input data by said at least one Bluetooth-enabled input device to said Bluetooth-enabled host in an HID report prior to said step of receiving said input data.

13. The method of claim 11 further comprising a step of converting said input data into TCP/IP packets in said Bluetooth-enabled host prior to said step of transmitting said input data from said Bluetooth-enabled host.

14. The method of claim 13 further comprising a step of extracting said input data from said at least one Bluetooth-enabled input device from said TCP/IP packets by said computer.

15. The method of claim 11, wherein said Bluetooth-enabled host is selected from the group consisting of an IP phone, a laptop computer, and a personal digital assistant.

16. The method of claim 11, wherein said communication link utilizes a TCP/IP protocol.

17. The method of claim 11, wherein said at least one Bluetooth-enabled input device is selected from the group consisting of a mouse, a keyboard, a microphone, a game controller, a touchpad, a touch screen, a joystick, a camera, a scanning device, and a fingerprint reader.

18. The method of claim 11, wherein said computer is an immobile computer.

19. The method of claim 11, wherein said computer is not Bluetooth enabled.

20. The method of claim 11, wherein said Ethernet link is implemented by using a cable selected from the group consisting of CAT5, CAT5e, CAT6, and CAT7.
